(19) United States
(12) Patent Application Publication
(10) Pub. No.: US 2009/0255742 A1
(43) Pub. Date: Oct. 15, 2009

(54) Self-contained & self-propelled magnetic alternator & wheel DirectDrive units aka:MAW-DirectDrives

(75) Inventor: Dana Allen Hansen, Torrance, CA (US)

Correspondence Address: Dana A. Hansen, 21105 Harvard Blvd., Torrance, CA, 90501-2923, US

(73) Assignee: Mr. Dana Allen Hansen, Torrance, CA (US)

(21) Appl. No.: 12/386,047

(22) Filed: Apr. 13, 2009

Related U.S. Application Data
(60) Provisional application No. 61/124,179, filed on Apr. 15, 2008.

(51) Int. Cl. B60K 1/00; F16D 55/18; B60K 11/00; F16J 15/00

(52) U.S. Cl. 180/65.31; 188/72.4; 180/68.1; 277/351

(57) ABSTRACT

MAW-DirectDrives are self-propelled independent direct drive units that connect to the inside of wheels. They rotate and stop electromagnetically and use the rotation of the wheel to generate electricity thru the incorporation of two frameless direct drive permanent magnets BLDC motors. They have one moving part, the integrated drive-plate assembly, a casted drive plate and spindle with an attached two-sided permanent magnets drive-rotor ring which engages and interacts with a customizable rear stationary power assembly responsible for supporting a vehicle and holding in position the two stators and optional air brake plus any sensors and accommodations for enhanced cooling formats. High constant torque eliminates the need for gearing and frees the second stator to harness the kinetic energy the vehicle produces during motion proportionate to the vehicle's linear momemtum plus allows every wheel on commercial vehicles to assist in its motion and power production.

### CROSS-REFERENCE TO RELATED APPLICATIONS

This non-provisional utility patent application will reference my customer number which is #000079682. This application will also reference my provisional patent application. That application number is: 61/124,179 which was filed on Apr. 15, 2008.

### STATEMENT REGARDING FEDERALLY SPONSORED RESEARCH OR DEVELOPMENT

“Not Applicable”

### REFERENCE TO SEQUENCE LISTING, A TABLE, OR A COMPUTER PROGRAM LISTING COMPACT DISC APPENDIX “Not Applicable”

### BACKGROUND OF THE INVENTION

1. Field of the Invention

MAW-DirectDrives are designed and created to reduce the on-board storage or production requirement of electrical power for electric vehicles that utilize the wheel format for their travel.

They are designed to increase the vehicle's efficiency by harnessing the kinetic energy within the vehicle during its motion in proportion to the vehicle's linear momentum by utilizing the rotation of every wheel to generate electricity and assist itself in its own production of electrical power, while simultaneously directly driving/propelling and braking each wheel independently with sufficient power/torque to move any size load without the need of gearing or the transmission of power from a central location.

They are designed to incorporate this ability economically into every format of land transport (road and rail) to pave the way for a future standard all electric format of propulsion for land transportation and end an era of reliance on non-efficient mechanical production of power and its transmission, thru the use of pollution producing products.

MAW-DirectDrives additionally are designed to incorporate today's most efficient and powerful electromagnetic propulsion, brake and electrical generating technologies to produce and create the power necessary for its application to encompass all formats of land transportation and enable a standard to be created for the propulsion of land transportation and for society to benefit/gain from that standardization.

MAW-DirectDrives through the incorporation of state of the art technologies in this manner will also produce an ability to create/induce rotation with more power and efficiency than today's single stator formats to be utilized wherever rotation is needed.

MAW-DirectDrives also reduce efficiency loss associated with electromagnetic power production and generation due to the affects of magnetic drag or the principles pertaining to magnetic attraction, to increase performance and efficiency.

MAW-DirectDrives design/form is uncomplicated to simplify the manufacturing and assembly process plus facilitate their smooth implementation into transportation vehicles; in addition it will enable the straightforward integration of future technology like radar and GPS communication and guidance via the computer's control without the need for alteration or modification for its accommodation.

2. Description of Related Art

Present transportation technology since its inception has used power-plants that utilize numerous mechanical parts to produce torque to rotate a wheel coupled with assemblies and mechanical devices adding more mechanical parts to the total, all to process and make that torque useable and ready for transmission to the wheel(s) via even more assemblies and mechanical devices, to propel a vehicle.

With these systems the efficiency is degraded every time the power/torque encounters friction, alteration, a change in direction or delay and when compounded with the torque originating from a rapid small diameter, possessing characteristics that require extensive processing and the use of these assemblies and mechanical devices, the torque produced by these power-plants in the end has degraded significantly and made the vehicle inefficient.

Present Hybrid technology is attempting to reduce the number of parts associated with the drive-train and eliminate the losses associated with those parts, but the torque being produced is still originating from a rapid small diameter and requires that processing and transmission, ultimately making the vehicle inefficient.

There are a few companies like e-traction in the Netherlands producing vehicles (buses and delivery trucks) that utilize a direct drive format where the electrical motor connects directly to the wheel eliminating the losses associated with a centralized power production format and they also realize the value that diameter plays in the production of torque ultimately eliminating the need for gearing but they have limited their torque production ability and efficiency with their designs inability to grow in diameter.

All Electric, Hybrid and Direct Drive technologies today understand the value of Electronic/regenerative braking and its value in stopping a vehicle while at the same time utilize the energy produced during the braking process to assist in decreasing the on-board demand for electrical storage or production, but they do not take advantage of the kinetic energy that a vehicle possesses during travel as they do in braking.

With today's rail transportation format being the architect of Hybrid technology, they and commercial trucking still resort to a central/core power-plant, causing to rotate a limited number of wheels to pull a heavy load that on the most part is supported on its own wheels just bearing the load and offering no assistance/help.

Using Newton's first law of motion and Einstein's mass-energy equivalence for understanding, the energy potential for any vehicle is proportional to their mass and velocity/momentum (linear momentum) and available to harness during the entire time of travel and one way to capture and harness that energy (kinetic) is to utilize the rotation of the wheels to essentially operate connected wind generators.

Thru the incorporation of state of the art wind generation technology and modern frameless direct-drive BLDC motors designed to be placed in large scale machinery without the need for gearing or mechanical braking, taking advantage of the gain increasing diameter affords to the production of torque, these two technologies united together as a unit to connect to each wheel on transportation will efficiently and smoothly propel and stop any size vehicle and continually generate electricity during motion in proportion to their linear momentum to pave the way to an all electric standard format of propulsion for land transportation.

By uniting the two technologies together in the design's configured state they become complementary and work together to reduce the end result associated with magnetic drag (not individually but as a unit) to increase the performance and further reduce the electrical demand.

### BRIEF SUMMARY OF THE INVENTION

“MAW-DirectDrives” are creative new propulsion units for transportation vehicles utilizing wheels for motion.

They're self-propelled independent direct drive units that connect to the inside of wheels.

They rotate and stop electromagnetically and use the rotation of the wheel to generate electricity thru the incorporation of two frameless direct drive brushless permanent magnets D.C. servomotors/BLDC motors.

They make possible an ability to capture and utilize the kinetic energy within the moving vehicle proportional to their linear momentum by the incorporation of the second motor/alternator.

They have one moving part plus their natural constant high power/torque production eliminate the need for efficiency reducing power conversion and transfer formats (i.e. gearing and differential).

A rear stationary power assembly is responsible for supporting a vehicle that connects to its annular shaped mounting plate and the mounting plate supports and holds in position two frameless direct drive brushless D.C. servomotor/BLDC stators on the inside around a cylindrical central wheel hub housing projecting in from the mounting plate an equidistance to the width of the stators. The mounting plate and wheel hub casting is designed for minimal machining and rapid assembly plus 9 accommodates the suggested custom air brake, various sensors and enhanced cooling formats.

The stators are separated and positioned face-to-face, to power and interact with, the two-sided permanent magnets drive-rotor ring which is located between and connected to the back of a drive-plate and spindle sub-assembly. The stator windings are matched to complement each other and their oriented to take advantage of magnetic principles to defeat drag and increase efficiency.

The spindle projecting inward/back from the drive-plate connects the Integrated drive-plate assembly to the power assembly by way of the wheel hub. To lock and secure both assemblies together and achieve a zero tolerance the gap between the tightened custom spanner nut and external retaining ring is filled with a thick spacing washer plus the appropriate amount of shim washers. The spanner nut's O.D. is also the surface the rear seal acts upon.

The spindle on units employing the custom air brake supports and facilitates travel and rotation of a brake-rotor that's kept disengaged by a strong die spring incorporated into the spindles end.

The brake-rotor is encased in a housing secured to the power assembly's mounting plate that incorporates an air-cylinder to apply pressure inward on the rotating brake-rotor to interact with an annular brake pad secured to the power assembly's mounting plate.

The unit's power potential is proportional to their size: essentially equating to the overall area of the permanent magnets, therefore increasing diameter affords the ability to increase the output to the desires amounts and benefit from a higher torque production ratio from the overall surface area of the magnets in proportion to the increase in diameter.

By utilizing MAW-DirectDrives on every wheel of extremely large loads such as mass transit, rail and commercial trucking each wheel contributes during all motion and compounds that input during breaking operations utilizing regenerative braking principles. The overall input generated by motion and braking will benefit greatly the efficiency of all vehicles and reduce the vehicle's demand for onboard power production or storage.

### BRIEF DESCRIPTION OF THE SEVERAL VIEWS OF THE DRAWING

This patent application includes eleven pages of drawings, tables and diagrams describing “MAW-DirectDrives” plus their properties and implementation.

FIG. 1 is a scale drawing of a cross-sectional view on the horizontal plane of a basic “MAW-DirectDrives” unit relying on natural convection for its cooling. This is the most energy and cost efficient version plus the easiest model to manufacture and implement.

FIG. 2 is a scale drawing of a cross-sectional view on the horizontal plane of a Compressed Air Cooled “MAW-DirectDrives” unit shown with an optional Custom Air Brake designed for the unit attached. Air circulation enters behind stators into the main cavity and exits out the front housing weather/dust seal.

FIG. 3 is a scale drawing of a cross-sectional view on the horizontal plane of a Liquid and Air Cooled “MAW-DirectDrives” unit.

FIG. 4 is a Numbered and Coded view of FIG. 2 for referencing to with the coordinating Parts and Specifications Description Table that follows.

FIG. 5 is a 3 page Table Numbered and Coded for describing the parts and features along with their specifications of a Compressed Air Cooled “MAW-DirectDrives” unit with an optional Custom Air Brake attached.

FIG. 6 is a shaded block diagram showing the most advantageous manner of implementation of MAW-DirectDrives into a four-wheeled automotive type layout.

FIG. 7 is a diagram and chart showing the relationship of the efficiency of Direct Drive Frameless Brushless Servomotors and the exponential gain in torque that increasing diameter affords.

FIG. 8 is a diagram and chart depicting a possible paring of stators made by Alxion Automatique & Productique and setting reference guides to compare three specific winds they offer and the relationship to efficiency the winds produce.

FIG. 9 is also a diagram and chart setup the same as FIG. 8 and using the next larger size set of stators produced by Alxion to show in addition the relationship that diameter has on the amount of torque produced plus the gain in efficiency increasing diameter affords.

### DETAILED DESCRIPTION OF THE INVENTION

MAW-DirectDrives originally filed as maw drive units in the provisional application, were and are created to improve the efficiency of transportation utilizing the wheel as their means of motion.

In the beginning with desire, motivation and extended deliberation, my focus of attention centered on the wheel and how to take advantage of their rotation to generate electricity in a manner similar to wind generators.

I first tried to incorporate this ability around their brakes, to transform this necessary mechanical action (requiring power and taxing without return to the vehicle) into a useful tool to assist in reducing the burden imposed upon the vehicle to produce this action.

Research brought about the awareness of various technologies along with their goods on the market today and facilitated my creation of MAW-DirectDrives.

By utilizing frameless direct drive motors designed for heavy machinery that eliminate the need for gearing and reduce/eliminate the need for mechanical braking, due to high constant torque production and electronic/Dynamic and regenerative braking, the entire conventional process of creating and transmitting torque from a central location by inefficient mechanical means can be eliminated and reduced to one moving part to rotate and stop a wheel regardless of the load it encounters/sustains and supports, plus by incorporating an additional frameless direct drive alternator, used within wind turbine generators, that will aid the vehicle and its demand for power through self-production generated by the rotation of the wheel itself feeding into the power supply, the vehicle's efficiency through the use of these technologies will pave the way to a standard all electric format of propelling all transportation on land.

This new creative design and its configuration, the placement of two frameless direct drive permanent magnets D.C. stators with identical winds, one being large and one smaller which are separated and positioned face-to face with matching orientation to one another, having between them a two-sided drive-rotor possessing on the inside and outside diameter surfaces equal numbers of rare earth magnet Arc-Segments located exactly on the same projection lines off center being equal in strength (preferably Neodymium grade N55) with both sides having the polarity on the larger outside radiuses matching (north or south), creates a tuned and complementary relationship that enables a lower end result in the losses associated with magnetic drag during the production/generation of electrical power by single units, therefore making their association in this format more efficient.

Additionally the benefit of gaining redundancy by the incorporation of the second stator gives peace of mind knowing if one stator fails a backup is always available for each wheel.

Larger frameless direct drive motors achieve their higher torque production through the use of more surface area and the dynamics that diameter plays in the effective output production efficiency of magnets than motors relying on high rotational speed with less torque and geared down to produce the required amount.

When the height of the rotor (length of individual magnet Arc-Segments comprising rotor) is kept within the optimum torque producing production range of 3.750″ to 8.500″ high, increasing the surface area of the magnets will increase torque production in proportion to the increase in surface area and as diameter is increased the effective output production efficiency of the magnet(s) rises, and MAW-DirectDrives design having both surface areas in close proximity and centered being engaged outwardly from both directions facilitates increasing the surface area to attain any output desired easy, while maintaining small dimensional proportions on the exterior.

A monumental advantage yielded by the design is their ability to continually transform the kinetic energy the vehicle possesses in proportion to the vehicle's linear momentum, and input back into the supply, electricity generated by each wheels second stator, until now this has been an untapped reservoir of energy just being wasted.

An improvement on the only present technology utilizing some of the kinetic energy within the vehicle, regenerative braking, involves the difficulty at present to fully store/garner Back-EMF produced by one large central motor, by distributing evenly the work load to the weight bearing locations (wheels) the reduced demand for power at the locations will be proportional to the number of locations distributed to, thus reducing the Back-EMF produced in proportion to the reduction ratio and making it possible to fully utilize the technology to its ultimate limits.

Relating to the preceding statement in conjunction with distributing the work load evenly to all weight bearing wheels; transportation sectors such as rail, mass transit and commercial trucking utilizing the distribution of responsibility for the vehicle's motion will reduce the output requirement at each location to a point easy to attain/produce and deploy, thus eliminating the need for a central power-plant format of pulling a load to one where the operator is monitoring and overseeing the central onboard computer system responsible for controlling the self-propulsion/braking, electrical generation and integrity of the power supply reserve/reservoir of separate individual rail cars/trailer units.

Relating to the previous statements; large loads employing multiple dispensation points for the distribution of responsibility to initiate motion will benefit the most from the technological gains the design bestows and if in the future all upward facing surfaces (vehicle rooftops) incorporated solar cells to produce power to maintain the power supply in daylight so the power supply can guarantee uninterrupted service at night, this will aid in reducing the need for off-site recharging.

The design will also benefit the efficiency of electronic/Dynamic braking and reduce/eliminate the need for traditional friction based mechanical formats during motion relegating that format for implementation as emergency/parking applications, the dispersing of the electronic braking action/force over such a large surface area of magnets will assist enormously in reducing loss associated with dynamic breaking's heat buildup and loss due to using a high power to surface area ratio because of having so little area to work on, the reduced ratio of power associated with the action will be proportional to the ratio of increase in surface area associated with the action and will increase the efficiency and effectiveness of the action proportionately.

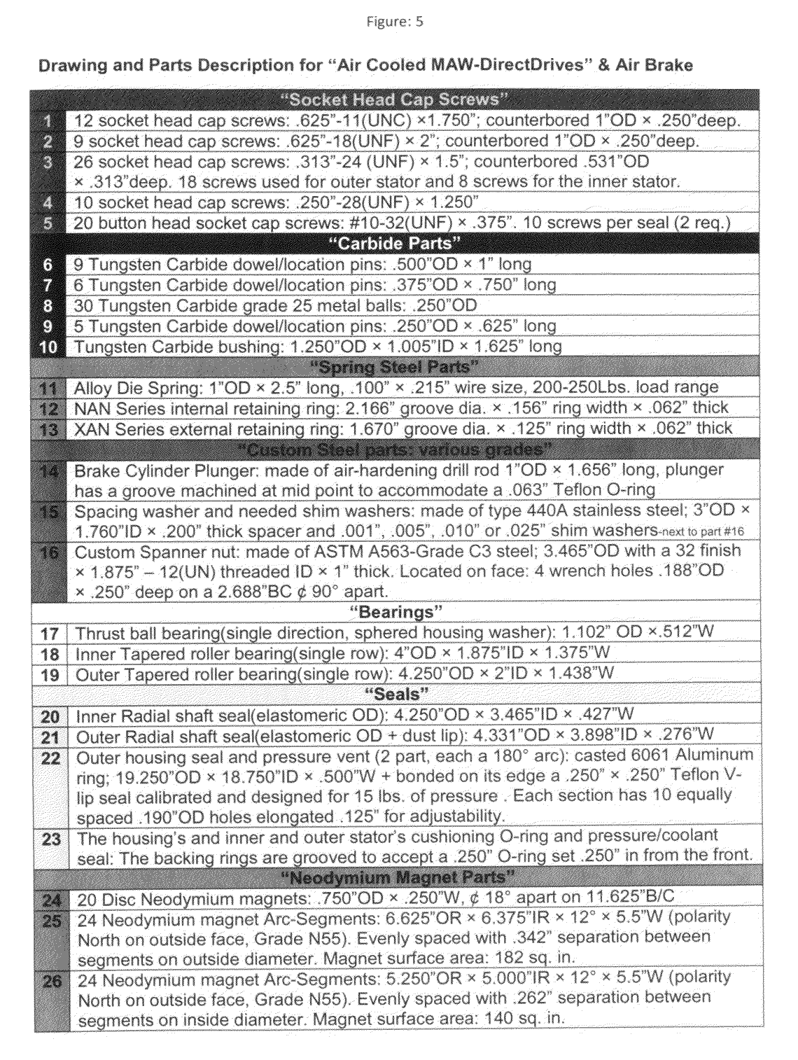

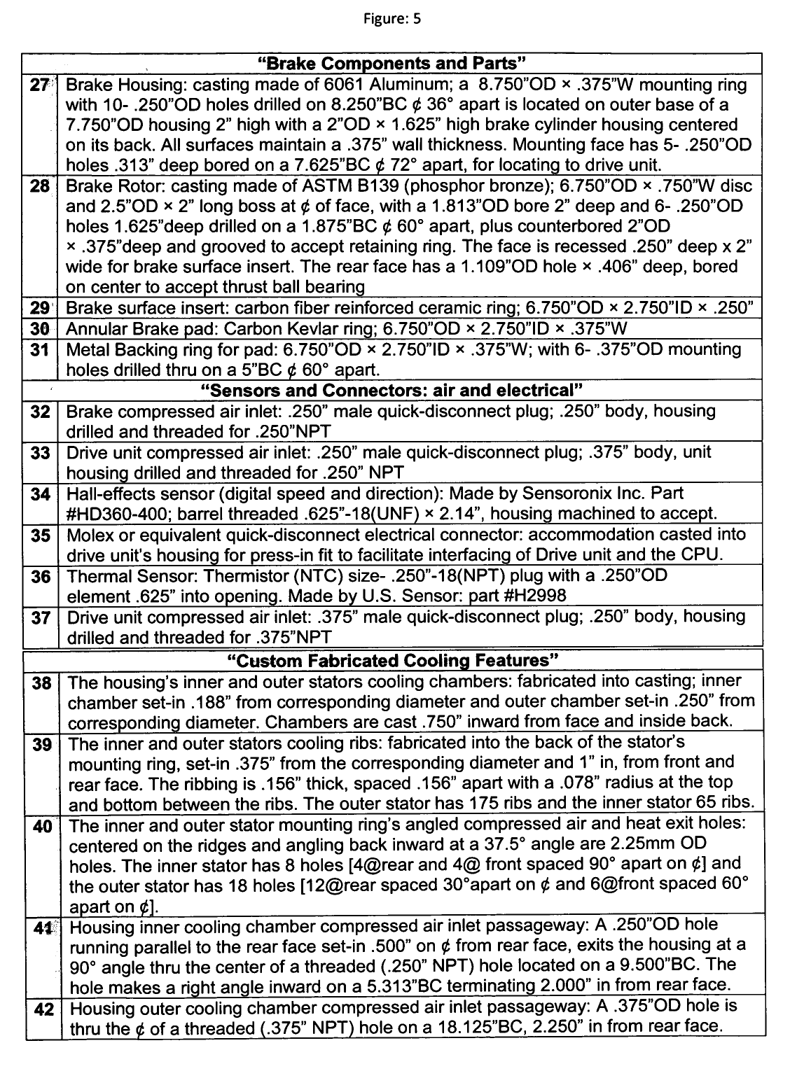

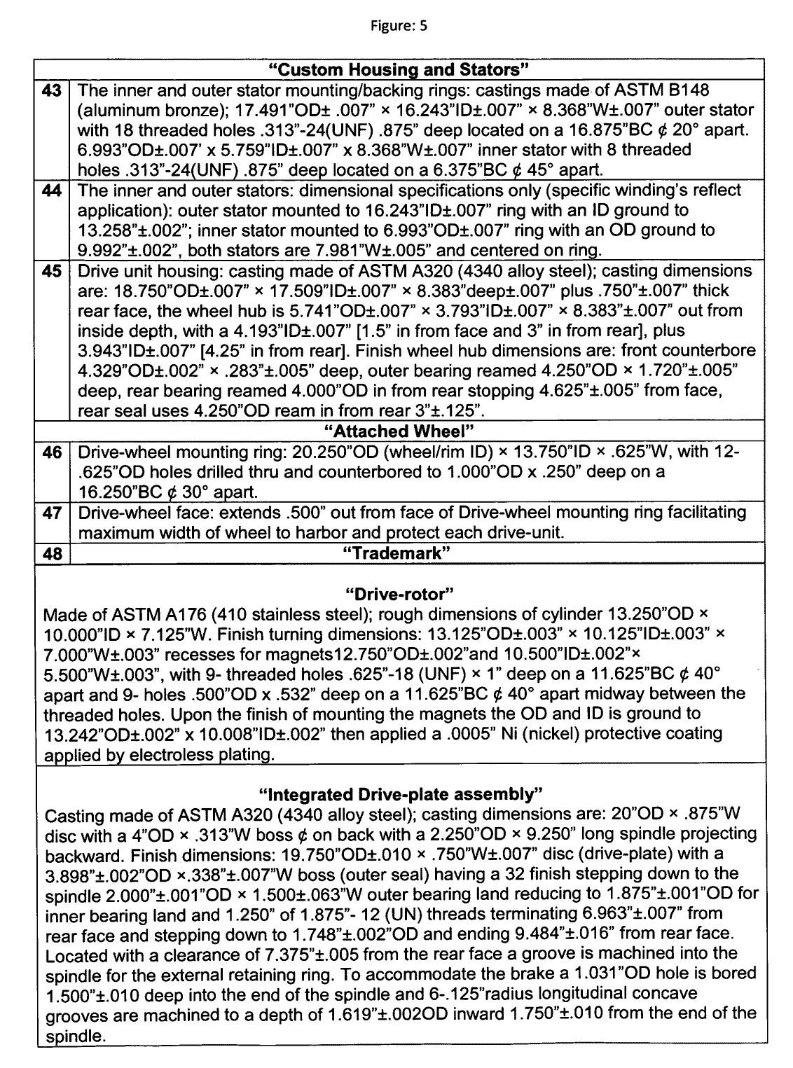

Although the design will allow incorporating various brake technologies and their manufactured goods on the market today a custom air brake design capable of utilizing any pressurized medium is shown in FIG. 2, and page 2 of FIG. 5 possesses the basic parts specifications for a typical application and the design incorporates state of the art components and materials to reduce friction on moving parts and heat associated with the braking process plus at the same time incorporate a greater surface area associated with the brake action within a smaller area allowing the unit's miniaturization.

For implementation of MAW-DirectDrives into vehicles in need of differential control of rotational speed for steering/navigation and are operating on conventional mechanical formats, incorporating a Rotary Variable Differential Transformer (RVDT) in a myriad of fashions at or around the steering box will impart perfect all-wheel differential steering independently by each DirectDrive unit; a typical example: connect to center of worm-wheel on steering lever/pitman arm and when bearings are dead ahead set RVDT center point and zero it in for right/left deflection.

For a steer-by-wire format enabling future collision avoidance and radar plus GPS communication and guidance via computer; attach to the inside of the dash and to the end of the steering wheel shaft coming in an Absolute Rotary Encoder zeroed in at a right angle to the horizontal plain setting the reference point and default position representing the dead ahead bearing and from here it is programmable to deflect right/left to the desired degrees/turning radius, the reaction time to initiate a turn and desired turning radius is proportional to the deflection and the length of time to reach that deflection and this information is sent to the CPU to control the linear motion slide (actuator) that is mounted horizontally in line with the tie-rod ends and attached to the track rod connected to those tie-rods, the linear motion slide's default position is dead center coordinating with the Absolute Rotary Encoder and mounted horizontally each side of center are 2 Linear Variable Differential Transformers (LVDTs) having a travel range equaling 55% of maximum linear movement of the slide and zeroed in to slide's default location, any linear movement right or left from default location for vehicle navigation will engage corresponding LVDT to coordinate and reduce electrical output by the CPU to the affected drive units proportional to the turn creating perfect all wheel differential motion for the best possible maneuvering and handling performance, safety and etc. . . .

Operator speed control and braking are accomplished using two identical pressure sensors, their computer controlled default setting is set for vehicle's stock-still position, speed and braking are proportional to the pressure applied and acceleration is proportional to the time it takes to reach that pressure, pressure reduction on speed sensor will automatically engage preset deceleration rate so the vehicle can fully utilize (store) all the energy produced during the regenerative braking process, a pressure release will decelerate vehicle to the default setting automatically at those preset rates and under normal driving conditions the brake sensor would not have to be used, the preset deceleration rate would be competent to stop the vehicle, in emergencies the brake sensor will react proportionately to the pressure in 3 ways: 1^{st}—by default the CPU will utilize the unit's regenerative braking abilities to take advantage of the energy produced and 2^{nd}—dynamic braking process enters into action when additional force is needed to bring vehicle to a stand-still and hold and 3^{rd}—when emergency situations arise it will engage the auxiliary braking format on units employing one.

MAW-DirectDrives are two separate assemblies that join together and interact to produce rotation, one assembly is stationary and responsible for supporting the vehicle/itself on its back and on the inside support two frameless direct drive permanent magnets D.C. stators around the outside of the central wheel hub housing projecting inward an equidistance to the stators, on basic units this assembly requires truing by simple machining procedures to the wheel hub interior dimensions only, the stators are positioned face-to-face and separated to allow between them, the insertion of the assembly responsible for interacting with the stators to induce rotation utilizing torque produced via the interaction of the two assemblies.

The rotating assembly being the only moving part is a strong sturdy casted metal disk/drive-plate with a circular boss and solid stiff well-built shaft projecting back on center, rough casting dimensions are set to require at least 0.125″ of material to be machined off on all surfaces, for casting ease the shaft dimension should be a single dimension set to the largest diameter and all the surfaces are machined true to maintain concentricity and perpendicularity to the stationary power assembly and known as the Integrated drive-plate assembly when completed, the assembly is responsible for locating and securing a rigid thickset cylindrical drive rotor projecting inward between the stators that is equipped inside and outside with matching rare earth permanent magnet arc-segments to coact in unison for the production of torque to produce rotation with one stator while the second stator reacts to the rotation to generate electricity to feed back into the vehicle's power supply/reserve to reduce the electrical burden of the vehicle that the vehicle itself inflicts/needs, the body of the cylindrical drive rotor at the end between the inner and outer rings of rare earth permanent magnet arc-segments bears by bonding numerous disc magnets evenly spaced to interact with a digital hall effects sensor entering from and secured by the rear of the stationary power assembly for rotational speed and direction information to be input into the computer for the computer's control of the unit(s), the circular boss and shaft portion of the drive-plate casting upon completion of all machining procedures become the driveshaft/spindle section that traverses through the stationary power supply assemblies central wheel hub housing to secure and join/lock the two assemblies together, the boss bears the ride of the front grease seal and the surface maintains a 32 finish to put forth a proper ride, the area of the shaft directly behind the boss has two riding surfaces, the first step down/land off the boss accommodates the inner taper roller bearing following with one slightly reduced in diameter and set back a distance to accommodate the outer taper roller bearing, slightly before the location point equivalent to the rear of the outer taper roller bearing the land/shaft is threaded for one inch with Unified Screw Threads and steps down to the ending dimension an amount slightly smaller than the bottom of the threads to preserve and maintain structural stability and soundness by retaining as much bulk as possible, farther down the shaft behind the threaded section on the final ending dimension resides the groove that accommodates the external retaining ring working in conjunction with one thick spacing washer plus the necessary and appropriate amount of shim washers to completely fill the gap between the external retaining ring and the tightened and torqued custom spanner nut that locks and joins the two assemblies together, the outer diameter surface of the custom spanner nut bears the ride of the rear grease seal and maintains a 32 finish to put forth a proper ride.

The Integrated drive-plate assembly on units without supplemental/auxiliary braking are dimensioned for the drive-shaft/spindle to die/terminate within the unit's housing in close proximity to the rear face of the stationary power supply assembly, leaving just enough clearance to facilitate the pressed in dust cap, this permits the spindle's length to extend as far as possible to take advantage and profit by dispersing the load over a broader area in relation to the positioning and arrangement of the inner and outer taper roller bearings to retain as much stiffness and rigidity as possible.

The Integrated drive-plate assembly's spindle on units utilizing the Custom Air Brake/pressurized liquid or gas actuated brake designed for rotating shafts within stationary housings in other words MAW-DirectDrives requires repositioning the rear components (taper roller bearing, locking spanner nut with space and shim washers plus external retaining ring) forward 1.250″ keeping their relationship the same and extending the length of the spindle enough to facilitate the travel of the brake rotor, bored into the end of the spindle is a hole to facilitate the desired die/compression spring engineered into that specific unit in relationship to its work load application, the outer diameter surface of the spindle's end requires milling six longitudinal concave grooves starting from the spindle's end and going forward the length of the brake rotor's travel making sure to have clearance/spacing to external retaining ring, the depth and the radius of the longitudinal concave grooves coordinate and correlate with the diameter and positioning of the incorporated tungsten carbide/hardened metal balls used within the rotor's incorporated ball spline which is the format used for its travel.

The Integrated drive-plate assembly's spindle on units incorporating supplemental braking formats like fail-safe or power-off technologies can be adapted to accept any of a large variety on the market today by simple splining, milling in keyways or slots, etc. . . .

The Integrated drive-plate assembly's drive-plate outside diameter should be set to the largest size unit within a particular manufacturers product line to enable all stationary power assemblies incorporated into the manufactures product lines to facilitate connection to a standard dimension that also coordinates with one standard wheel diameter offered in various widths according to load, the wheel/rims ideally should only utilize a mounting ring three inches wide or so mounting to the outer perimeter of the drive-plate possessing the threaded mounting holes thus reducing the manufacturing costs for the wheels and eliminating a lot of the overhead associated with wide inventories and the burden to stock them.

The Integrated drive-plate assembly's face being flat because fastening devices for securing the drive-rotor are machined in and designed to be flush with the face allowing the entire face to be used for positioning threaded mounting holes wherever the manufacturer desires, allows the manufactures to initially design in their present inventories or trademark items.

The rear face of the Integrated drive-plate assembly's drive-plate is the initiation point to institute machining procedures for the locating and positioning of the drive-rotor, all location holes bearing location pins are bored to proper depth having flat bottoms and all mounting holes mating to threaded holes in the drive-rotor are through drilled then afterwards counterbored/countersunk to proper depth from the front face of the drive-plate, all holes will be equally spaced apart and located on the median diameter that the drive-rotor manifests/equates to, and will be precisely dialed indicated in relation to the spindle to maintain concentricity and perpendicularity to the spindle.

The Integrated drive-plate assembly casting is capable of being constructed/manufactured using a variety of metal alloys on the market today, alloys with qualities, properties and characteristics equaling at least ASTM A320 (4340 alloy steel) will produce a fine product without the need of additional engineering ingenuity or machining procedures needed to compensate for material weaknesses.

The two-sided permanent magnets drive-rotor ring/cylinder sub-assembly body casting starts out as an 0.125″ oversize O.D. and 0.125″ undersize I.D. cylinder 0.250″ over in length and is machined to bring into finish dimensions, the casting being the area between the magnets needs to be solid, hard, rigid and an excellent conductor of energy, to transport and transmit the torque generated by the coactions of the stators and rare earth magnets that are affixed on itself, to the drive-plate to commence rotation with as little expansion and deviation from its dimensional and positional specifications due to heat, stress or any related adverse effects, the load bearing properties/characteristics imposed upon the unit will determine the wall thickness/breadth of the drive-rotor's body, when this dimension is determined it will span/stretch the length of the individual rare earth permanent magnet arc-segments that comprise the two-sided drive-rotor, then step-out/expand in both directions 0.039″/1 millimeter less than the thickness of the individual rare earth permanent magnet arc-segments, that dimension will continue through to the drive-plate for its connection, the final overall height/length will be determined by the distance from the rear face of the drive-plate to the innermost point of contact in regards to the alignment of the rare earth magnets to the stator for operation, the median diameter of the drive-rotor in relation to its wall thickness will identify and represent the bolt circle that all location holes and threaded mounting holed will be machined on, the proper screw diameter will be equivalent to 50% of the drive-rotor thickness at the connection point with the drive-plate, it will utilize Unified National Fine screw threads to a minimum depth of 1.000″, located on that same median diameter at the opposite end, on the body between the inner and outer rings of magnets are neodymium disc magnets that are evenly and equally spaced using a size that will have an episode of contact/incident frequency with the digital Hall-Effects sensor coming in and secured by the stationary power assembly's rear face not exceeding the desired operating frequency range of the sensor when operating at the highest R.P.M. A typical example is: operating frequency range of sensor is 1 Hz to 15 kHz and the drive unit's maximum operating speed is 750 R.P.M. divide 15,000 by 750 and the answer is 20 so you utilize 20 magnets positioned 18 degrees apart on center and if possible sized to create a 50% duty cycle

The structural properties of the material/metal alloy was just laid out, now a couple of physical properties come into action to create a good surface for mounting the rare earth magnets and a long lifespan without degrading in character/integrity and facilitate an expeditious assembly to reduce cost, use an alloy that is magnetic, by having the individual rare earth magnet arc-segments possessing identical polarization/polarities on the larger radiuses they will attract together to the drive-rotor body and in essence act like large individual magnets, the mounting process looks something like this: using a jig or something to maintain proper spacing of the external magnet arc-segments apply the bonding agent (a Cyanoacrylate type for operating under 275 degrees Fahrenheit) to outside and place segments and if their outer radius is north the south side attracts, attaches and adheres to the outer surface, now on the inside utilizing a similar jig to maintain alignment in relation to each other, apply the bonding agent and the inner segments having the larger radiuses north (matching outer segments) will naturally attract to the surface above having became essentially south by the previous operation and attach itself and adhere, an excellent metal alloy to use for this application that offers good resistance to weathering and all the previous qualities is ASTM A176 (410 stainless steel).

Magnet compositions vary and each offer distinct characteristics Neodymium magnets are capable of producing the highest amounts of gauss which is the measurement of the magnetic flux density, expressed: MGOe (megagauss-oersteds), they have a range from 22MGOe to 55MGOe on the market today but the most powerful versions can only operate up to 176 degrees Fahrenheit, high temperature grades can operate up to 446 degrees Fahrenheit, but as temperature capabilities rise MGOe amounts decline making the highest temperature grades just barely more powerful than Samarium Cobalt magnets that can operate in the range from 482 degrees to 572 degrees Fahrenheit and producing 20MGOe to 32MGOe for series 2:17 type and producing 16MGOe to 25MGOe for series 1:5, in regards to statements in: [0048] and [0049] magnetic flux travels at right angles from their surface as the diameter increases the magnetic flux has a larger cross-section to react upon by lengthening and smoothing the curve allowing more of the flux to be utilized and not scattered in various directions and making the same size area more efficient, once the proper type magnet composition has been determined the individual magnet arc-segments are ordered by their inside radius and outside radius equating to their thickness plus their width (length) and the number of arc degrees it occupies in space at its location (equating to the segments width in appearance), when the mounting of the magnets have cured the drive-rotor sub-assembly is brought to finish dimensions on the inside and outside surfaces bearing the magnets by the process of wet grinding to tolerances of ±0.002″ then applied a 0.0005″ (5 ten-thousandth) Ni (nickel) protective coating applied by electroless plating.

The basic stationary power assembly casting is a Precision investment casting of a tough sturdy durable and dependable metal alloy annular shaped mounting plate and matching built-in inward projecting cylindrical central wheel hub housing, all exterior surfaces are casted to the finished dimensions and require no turning/machining procedures to bring into tolerance, the rough casting dimension for the inside diameter of the wheel hub housing will be 0.375″ smaller than the outside diameter of the tapered roller bearings, the casting will be made of ASTM A320 (4340 alloy steel) or at least its equivalent when desiring the minimal machining this material grade offers, engineering ingenuity can be utilized to make use of inexpensive aluminum alloys like working in conjunction with hardened threaded inserts for mounting locations and beefier dimensions associated with the mounting plate and wheel hub housing breadth, if desired the wheel hub housing interior can be casted to dimensions reflecting the finish internal configuration needing only reaming operations and one counterboring operation after the casting has been dial-indicated in on the wheel hub O.D. (front and back) and the outer perimeter of the inside face of mounting plate to bring into proper concentricity and perpendicularity between those surfaces before commencing any machining procedures, once the front section of the wheel hub housing is finished all dimensions and locations are true to one-another, then the casting is reversed and chucked up on the wheel hub O.D. and dial-indicated in near the same locations then the remaining machining procedures are performed into the wheel hub plus in and on the rear face from this angle, the threaded hole for the Hall-Effects sensor is located on the median diameter/bolt circle of the drive-rotor and is basically the center point for the cluster of input/output connections for the unit's operation, if the desired connection format for the stators requires a backplane to be inset/pressed into the housing, the hole configuration can be included with the casting but this relegates that casting to that configuration only which reduces machining time but increases inventory costs, otherwise a quick and efficient format is just to drill an oversize hole for the stators to incorporate a Molex or equivalent connector at the end of the power cable to easily pass through then use a two-piece rubber grommet to insert for seal, this format allows the casting to be more universal, when thermal sensors are incorporated their threaded hole will be located in this region, the stator(s) mounting holes along with their counter bores will be located on the median diameters of the inner and outer stators mounting backs and match their size and locations, the remainder of drilling and threading procedures for basic units pertain to threaded and location holes for their mounting/connection to surfaces or vehicle suspensions.

An easy and simple format to connect to front or steerable suspension is basically taking the steering knuckle and dividing it in two, half on top and half on bottom, the castings would be described in the following manner: two-part steering knuckle consisting of two heavyweight rectangular mounting bases each having three holes, one hole on the inside edge at each end and one on the outside edge at center, even with the inside edge between the outer holes a heavyweight rectangular bar projecting out at right angles from all directions to facilitate upper and lower ball joint holes and lower half projection taking the form of an L shooting backwards representing the lower control arm possessing the hole for its connection to the tie-rod.

Stationary power assembly castings for basic units do not need to conform to restrictions on diameter or wheel hub length, as suggested in [0064] about the manufacturer making the drive-plate diameter as large as possible to enable all stationary power assemblies to engage to it, the same situation or suggestion applies here, there is no reason why an oversize casting cannot be used to house and hold/secure a smaller set of stators (stage), in either direction, the stators are merely placed in position and secured anyway and when the width (height) come into play and falls short you just have a longer drive-rotor to contend with and actually when undersize stators are deployed you just have more cooling area in and around them and that doesn't hurt, so when adopting this strategy you are stocking the two castings that are set to the largest and heaviest standards that can be used for every version to enable the best purchasing price and least inventories.

The stationary power assemblies can incorporate all varieties of frameless direct drive permanent magnets D.C. stators marketed today, most on the market today do not use the ideal metal alloy in their mounting backs for efficient heat dissipating when operating with natural convection as the cooling format, which by the way appears from present specifications on available goods to be the most efficient because the winds they incorporate do not produce as much heat, but they are bulkier, to maintain a strong dimensional stability plus be tough rigid stiff and have excellent conduction an ASTM B148 (aluminum bronze) casted mounting back possessing external ribbing that circumnavigates the entire diameter that is set-in from front and back 1.000″ plus set-in to the depth 0.250″ from the bottom with the cooling ribs 0.156″ thick being spaced 0.156″ apart and having 0.078″ radiuses at the top of the ribbing plus between at the bottom, the stator is positioned on the center of the mounting back which has a 0.188″ ledge to each edge, the threaded mounting holes will be located on the median diameter of the mounting back and equate in diameter to 50% of the thickness of the mounting plate and machined to a depth of 0.875″, not to exceed 3.000″ spacing on center, with this configuration of material and design cooling will be enhanced.

At this stage of MAW-DirectDrives description; a basic unit utilizing natural convection as the cooling format and the housing without a seal, some of the many self-enclosed applications providing their own protection from the elements are: large centrifugal pumps, heavy machinery that presently use frameless direct drive motors or can use them, elevators and cranes, any situation needing efficient high torque production especially where space is limited, subways or anything using a large motor to maintain rotation of a flywheel in conjunction with a clutch, present wind turbine generators gain with dual stators able to produce more in practically the same space and etc.

When the application of MAW-DirectDrives are subjected to the elements of nature and/or the road, protection is needed and if the protection were incorporated internally servicing and repair/replacement would entail disassembling the unit and everything associated to make it possible, so having an external housing seal allows access to the seal for maintenance and repair/replacement, incorporating adjustability into the seal allows designing into the seal a hinging action capable of exerting a specified pressure/force with proper adjustment, with a “V” design; the adjoining side of the seal mating to a metal backing/mounting ring is flat plus bonded together and the vertex is located inside that bears the hinging properties, with this format exterior forces apply pressure to opening only to increase the pressure/resistance to its entry but when internal pressure reaches the hinging specification it exits, this format allows not only incorporating compressed air-cooling abilities into the housing but regulating the seals ride against the rear face of the drive-plate to extend its lifespan, finally having an externally accessible and adjustable circular housing seal requires it to be split in two for easy service and repair. The seal then is described in the following manner: an annular two piece adjustable external housing seal and pressure vent comprising two parts each a 180 degree arc, each parts body is a 6061 Aluminum casting 0.500″ wide by 0.250″ thick with the inside diameter matching the outside diameter of the housing and bonded on its edge is a 0.250″ high by 0.250″ wide Teflon V-lip seal calibrated to vent at 15 pounds of internal pressure, each part has ten 0.190″ diameter holes elongated 0.125″ for adjustability that match the housing's 20 equally spaced threaded mounting holes around its forward perimeter and starting locations are 9 degrees inward from the 180 degree plane centered 18 degrees apart.

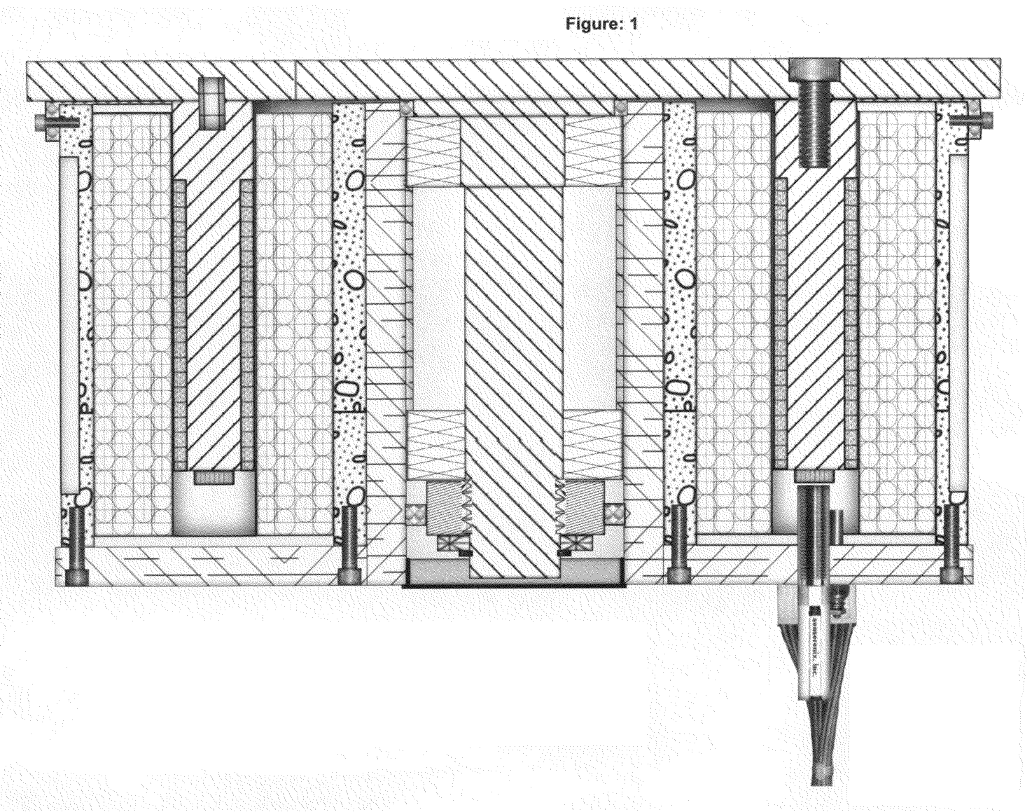

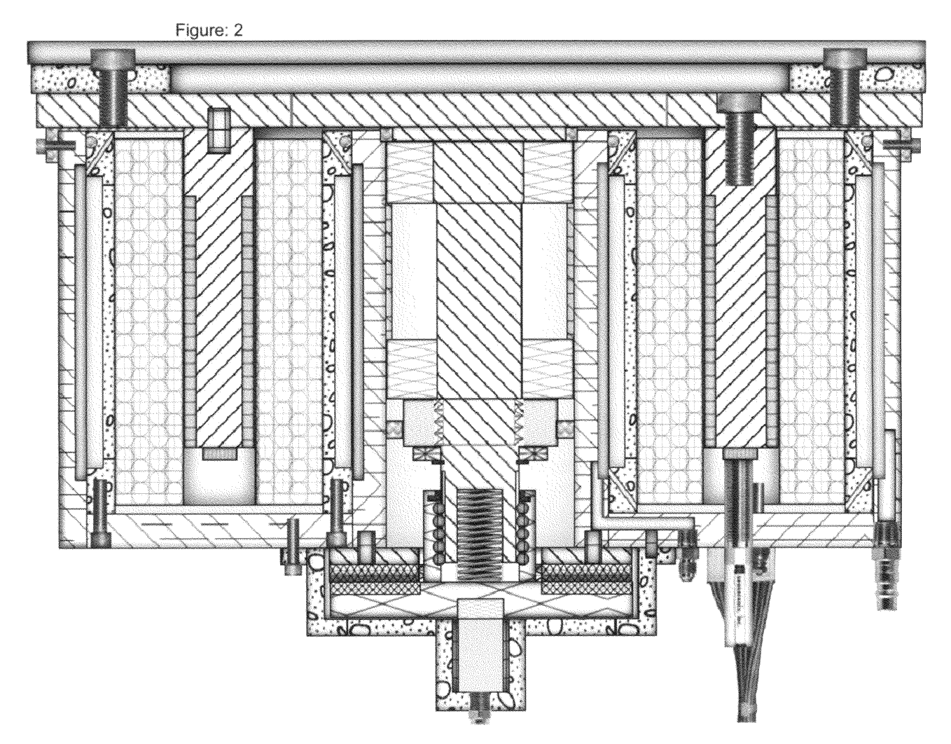

At this point the basic MAW-DirectDrives unit utilizing the custom outer housing seal is fully functional to incorporate into transportation and shown in the cross-sectional view drawing presented in FIG. 1

To aid in the ability to use neodymium magnets and gain by their reduced cost plus greater strength you can take the basic unit and enhance its cooling potential by adding an external wall that has a recessed chamber which will also be set-in to the wheel hub O.D. that corresponds in position to the stator's cooling ribs outlined in [0074] and force refrigerated compressed air into the cooling chambers that exit into the center of the housing, primarily the rear, via angled holes in the stator mounting backs exiting out the ledges on each side of the stator, then the circulating air is forced between the drive-rotor and outer stator out of the housing behind the seal which further reduces the seals friction against the drive-plate with the outgoing pressure preventing the entry of anything, to prevent air escaping out of the chambers behind the stators and lose directionality an O-ring is incorporated into the front of the backside of the stator mounting back, the total overall surface area of the angled exit holes on each stator should not exceed the surface area of the input line so the pressure can be channeled in the direction you want, on the inner stator you want at least 50% of the pressure to enter at the front of the housing so it can be forced between the inner stator and drive-rotor towards the back for its cooling, as long as the pressure is exiting out from the housing relieving the internal areas, air circulation will constantly be traveling towards areas of lower pressure. A typical setup with this format is presented in FIG. 2 and retains these specific specifications: Outer wall equal in height to stator 0.625″ thick, sunken chamber 0.250″ deep and 0.750″ inward from face and inside back, a 0.375″ diameter input hole centered within wall terminates 0.750″ into chamber and started through the center of a 0.375″ NPT threaded hole on the rear face of the stationary power assembly outfitted with a 0.375″ male quick-disconnect plug that has a 0.250″ body for the connection to the computer controlled air valves fed by the air compressors refrigerated storage tank, wheel hub O.D. sunken chamber 0.188″ deep positioned to match outer wall with 0.250″ diameter input hole centered 0.188″ in from outer surface terminating 0.500″ into chamber and started through the center of a 0.250″ NPT threaded hole on the rear face of the stationary power assembly outfitted with a 0.250″ male quick-disconnect plug that has a 0.375″ body for its connection to a second air valve, the stators mounting backs rear faces are grooved 0.250″ down from their face (top) to accept a 0.250″ O-ring, the stators are positioned so as not to exceed 0.032″ clearance between their walls to maintain a proper O-ring contact, the ledges on each stator mounting back are angle drilled at a 37.5 degree angle back toward cooling chamber with 2.25 mm diameter holes, the outer stator receives 18 holes, 12 at the rear drilled 30 degrees apart on center and 6 at the front drilled 60 degrees apart on center, the inner stator receives 8 holes 4 at front and rear drilled 90 degrees apart on center. The casting for this enhanced cooling format like the basic stationary power assembly is a Precision investment casting also casted using ASTM A320 (4340 alloy steel) or equivalent and all dimensions other than the wheel hub I.D. are casted to finish specifications including the incorporated cooling chambers, when an optional custom air brake or any centrally mounted brake is used that prevents direct drilling input holes into cooling chambers thus requiring redirecting to another entry point all internal passageways are incorporated into the casting, finish machining utilizes the same procedures in the same order, there is one exception to this rule; if it is desired the front internal lands on the casting that contact the O-rings can be sized to require bringing into dimension which then would require a corresponding change to the casting plus the additional two turning procedures.

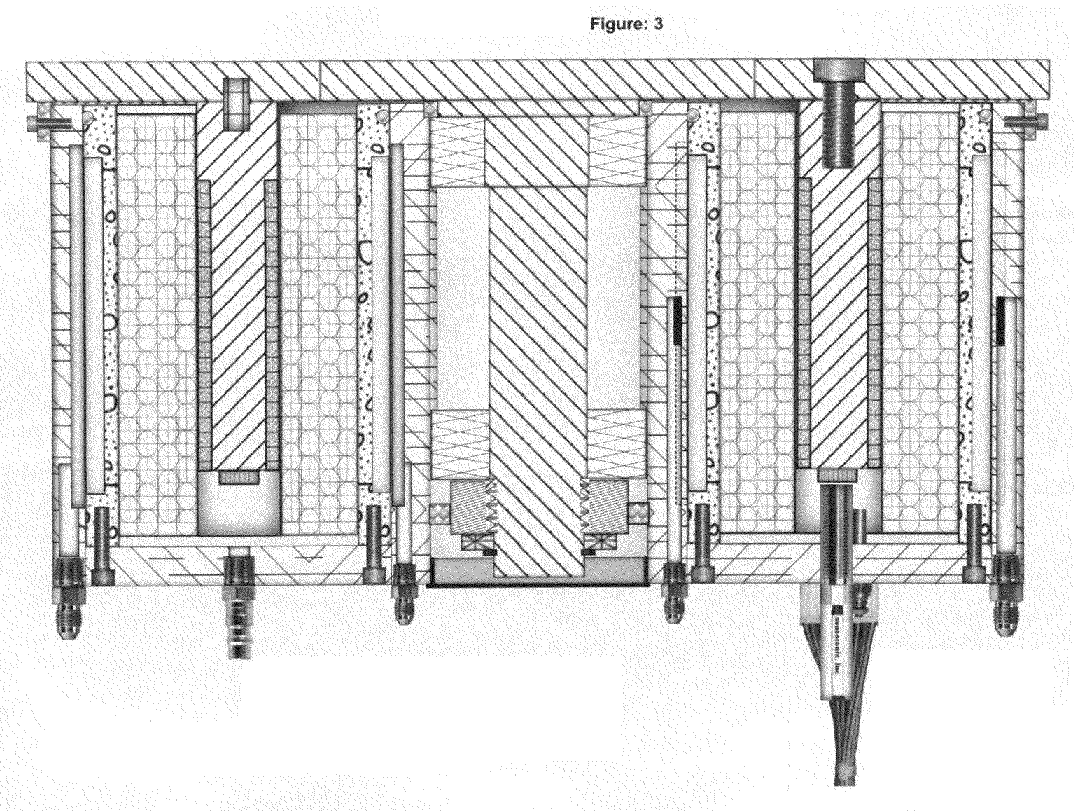

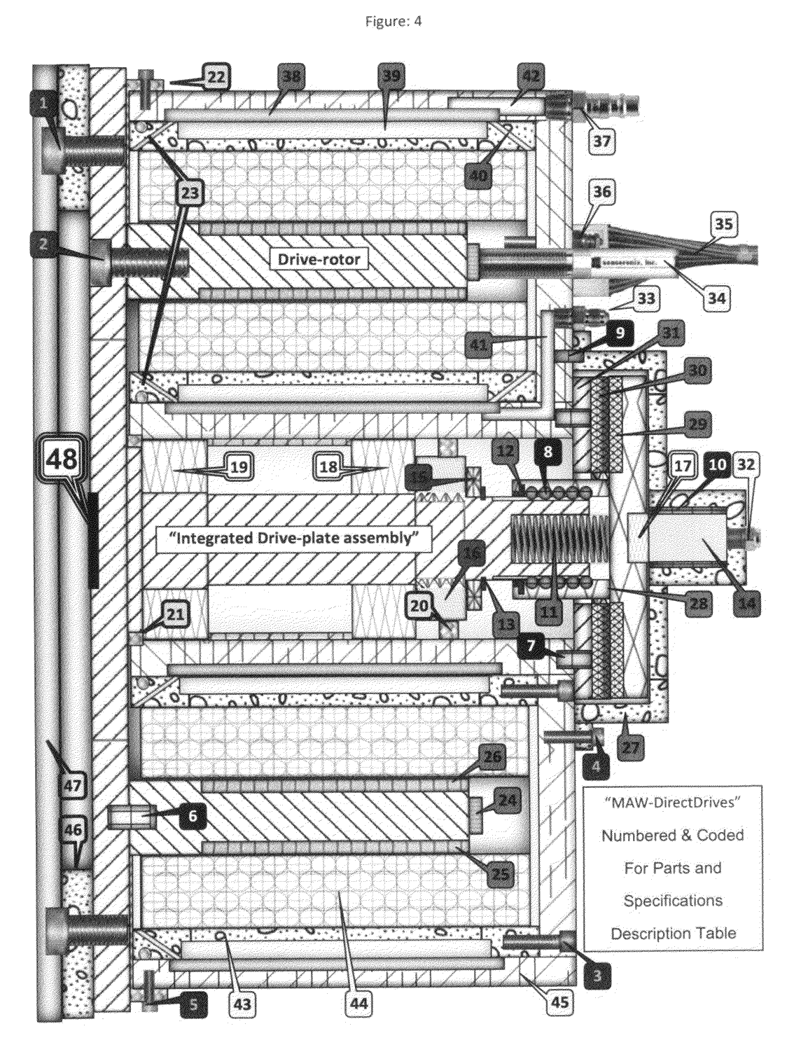

A liquid and compressed air combination is another alternative to enhance the cooling ability of MAW-DirectDrives and is shown in FIG. 3: this utilizes the same basic casting as the compressed air cooled version with one change to the casting specifications that being adding a partition wall going from front to back 0.625″ wide in both cooling chambers the height of the depth of each chamber making them flush with the surface, with this version there is an input and output hole going into both chambers that are separated 2.125″ on center and positioned an equal distance out from the centerline of the partition wall, the two inner and the two outer sets match the specifications of the compressed air cooled version 0.375″ with the outer and 0.250″ with the inner, the fittings that are used have the same NPT threads going into the housing but have threaded connection points for the two input lines coming from the computer controlled coolant valves that control the flow of the pressurized reservoir being maintained by the submerged pump at the base of the radiator and the two output lines going to the radiator, the stators incorporate the O-rings in the same fashion but do not need the angled holes, so what happens is the coolant enters each chamber on one side of the wall travels around the circumference and exits on the opposite side of the wall, for additional cooling inside, compressed air enters through a male quick-disconnect plug incorporated by a threaded hole positioned in the vicinity of the Hall-Effects sensor being supplied/fed in the same manner as the compressed air version.

Although MAW-DirectDrives can incorporate a array of brake technologies on the market today I believe the design that I came up with is the best suited for this type application; the brake design is shown on FIG. 2 attached to the compressed air version; the design allows using any pressurized liquid or gas medium capable of actuating/engaging the motion/movement of a piston/plunger within a cylinder, it utilizes state of the art braking materials that are more efficient at stopping and reducing heat during the braking action that are found on formula race cars but considered too expensive for use on passenger vehicles, but the design allows these materials to be reduced dramatically in volume/amount to make them economically feasible while at the same time have more surface area involved during the action making them more effective in a smaller area, all this while incorporating the best friction reducing formats of operation. Previously explained within section: [0062] was how to prepare to spindle to accept the ride/travel of the brake rotor's incorporated ball spline which is the type/format of travel decided upon due to its friction reducing properties and the extended life it promotes in the product, the brake rotor is casted using ASTM B139 (phosphor bronze) because of its conductibility, hardness, tensile strength, durability, cold-working and mechanical properties it takes the form of a heavy disk and circular boss projecting inward that houses the ball spline, the boss will have six holes bored the depth equaling the travel 0.005″ larger than the Tungsten Carbide/hardened metal balls being utilized, the holes will be bores centered on the diameter facilitating engaging spindle with a minimum of 0.062″ penetration, the boss will be bore in the center to the same depth a diameter 0.032″ larger than the spindle's O.D. and counterbored to a depth to incorporate a groove with associated internal retaining ring and diameter to allow free unobstructed travel (greater than boss's I.D.) when the O.D. of the boss is determined the O.D. of the disk (brake rotor) will be 4.250″ larger and generate the size of the annular brake pad with its metal mounting back set at a 2.000″ wide surface, inset into the brake rotor by recessing the outer perimeter is the brake surface insert constructed of carbon fiber reinforced ceramic, this surface then comes in contact with the annular brake pads Carbon Kevlar surface attached to the mounting back that is being supported and held in position on Tungsten Carbide/hardened metal dowels/location pins drilled and pressed into the rear face of the stationary power assembly, centered on the front face of the brake rotor in a 0.005″ oversize hole bored to a depth allowing its slight protrusion is a thrust ball bearing that come into contact with a brake cylinder plunger made of air-hardening drill rod that possesses an O-ring centered on its exterior (during assembly can be installed in either direction) that moves/travels within a tungsten carbide bushing pressed into the outer brake housing's brake cylinder projection jutting back from the center that houses and secures the input line (if air a male quick-disconnect plug), the outside diameter of the housing is 1.000″ larger than the brake rotor and casted having a 0.375″ wall thickness throughout the entire casting, coming off the outside of the casting at the base is the mounting ring which is 1.000″ larger in diameter by 0.375″ high, the mounting ring possesses ten equally spaced 0.250″ diameter holes to work in conjunction with threaded mounting holes located on the rear face of the stationary power assembly, the housing is cast using 6061 aluminum

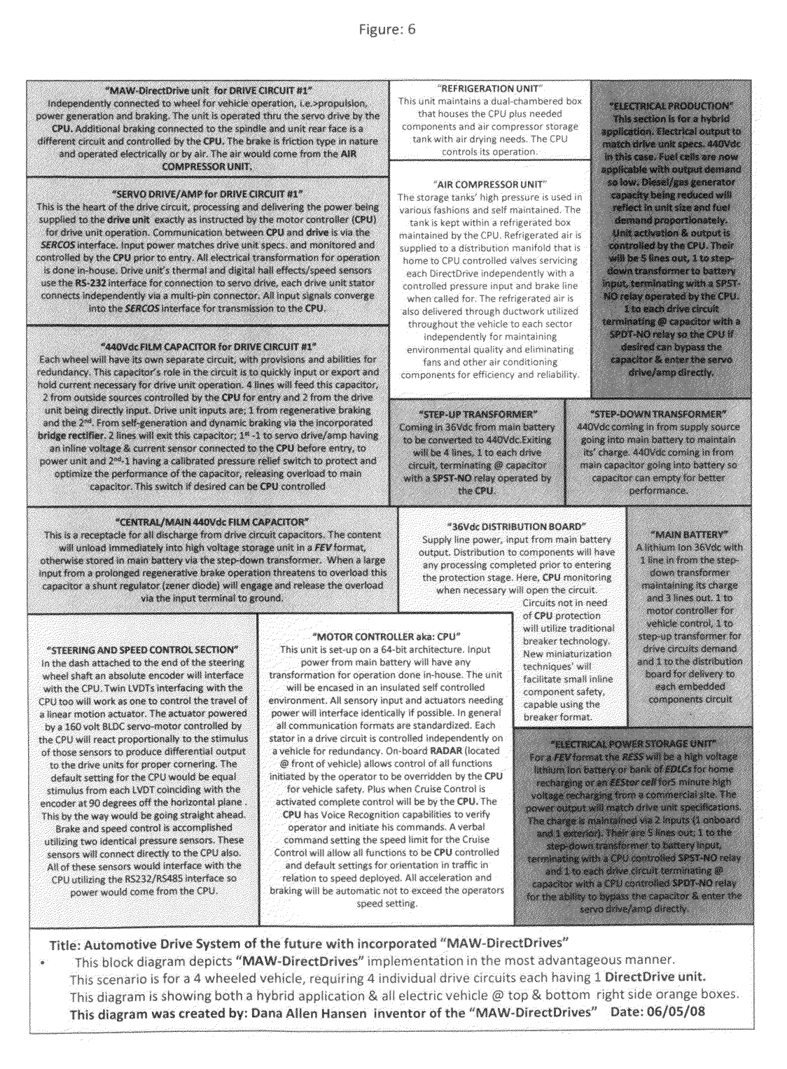

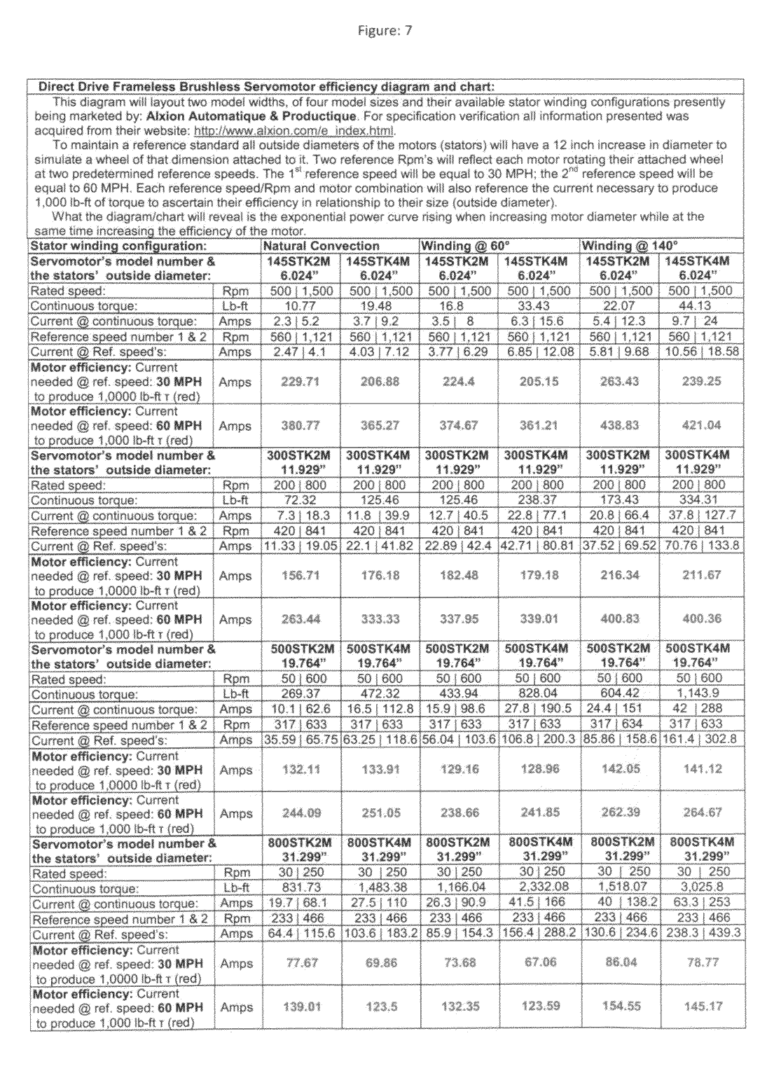

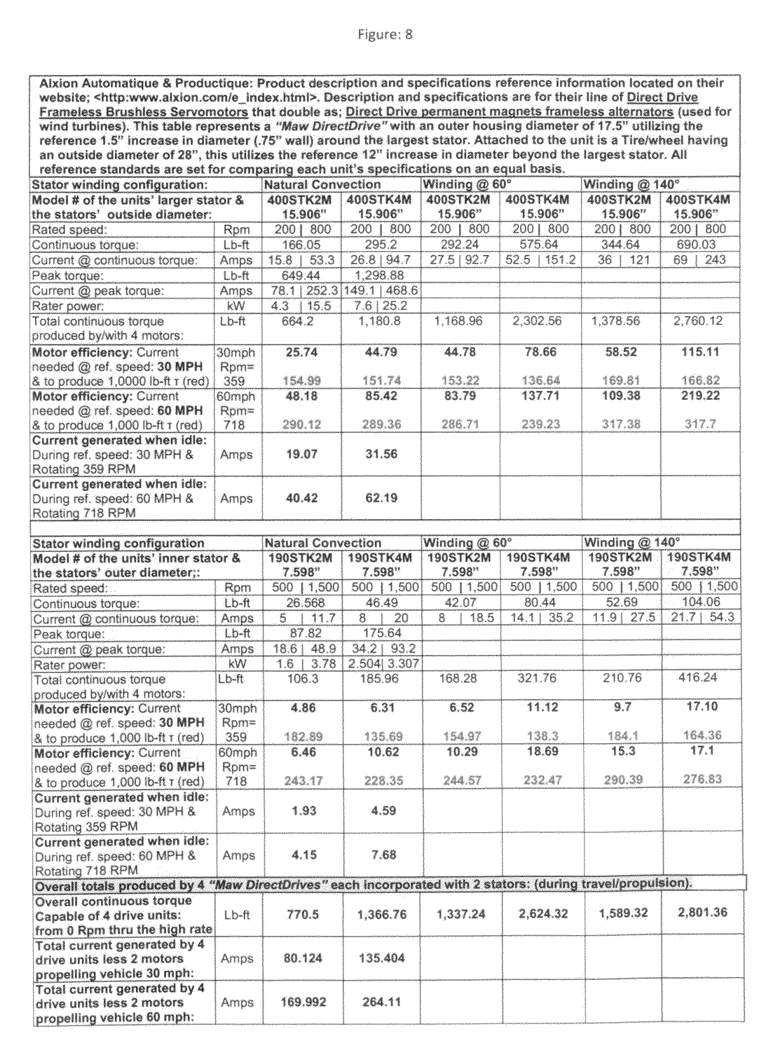

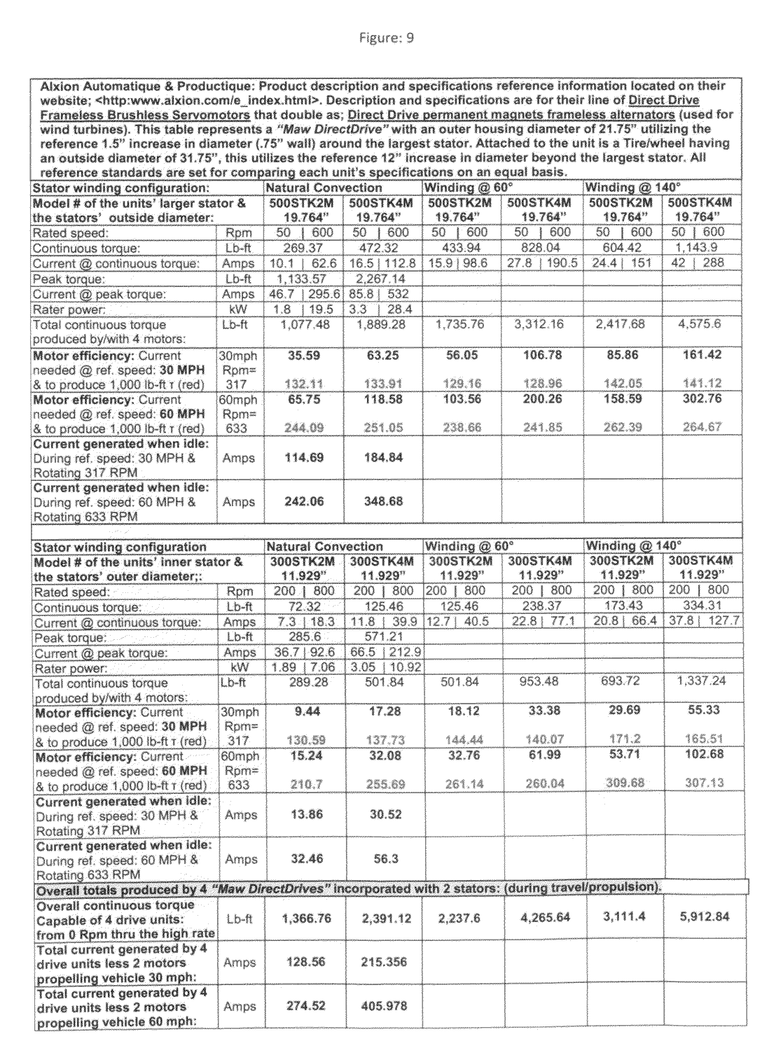

A unique way to setup a vehicle to implement MAW-DirectDrives in an efficient manner is shown in a block diagram in FIG. 6; the basic idea: having each unit's stators charge a film capacitor dedicated to its own drive circuit. The only diversion and loss of efficiency is the computer's control, with 8 stators at the computer's control, all capable of propelling, stopping and generating equally, under normal driving, at least 50% of the stators will be inputting electrical energy back into the system, coupled with the additional input from regenerative braking, the film capacitor (setup to the same operating voltage) will be assisted in its own needs to maintain a specified reserve reducing the demand from a central source. The capacity of the film capacitor is greater than needed to operate the vehicle under most conditions and to make sure capacity level is set for rapid input, a calibrated pressure relief switch is used to release any overload to a central film capacitor for disposition. The central/main capacitor will empty into the main battery via a step-down transformer or directly into the high voltage storage unit in an all-electric configuration and when overloaded by prolonged regenerative breaking a shunt regulator (zener diode) will engage and release the overload to ground. The vehicles main battery will be a 36Vdc Lithium-ion polymer. The high voltage supply feeding each drive circuit's film capacitor is controlled by a relay switch under the computer's control. The film capacitor's high voltage input will be from 1 of these formats: hybrid configuration or all electric. The hybrid configuration would be either diesel/gas generator or fuel cell. The all electric configuration would utilize a lithium-ion polymer battery pack or a bank of electric double layer capacitors (EDLCs) when set-up for home recharging, when set-up for a 4 or 5 minute high voltage recharge from a commercial site an EEStor cell would be utilized. One last detail the main batteries' output will go to 3 locations: 1st to the computer operations center for vehicle operation, 2nd to the distribution board for delivery to embedded components, and 3rd to a step-up transformer for delivery to each drive circuit when needed.

A clean and simple layout for the vehicle's dashboard to reduce fabrication and assembly time plus associated costs is unbelievably simple: the steering control which has twin grips, one at 10 o'clock and one at 2 o'clock, each have 3 embedded pressure sensors (1 for right turn signal and 1 for left turn signal actuation, plus 1 for cruise-control activation). Directly behind the steering control is located the flat panel display inset into the dash. This will display all the information the driver needs to operate the vehicle in a style configured by the driver. All the controls for the vehicle's various embedded components will be accessible via a touch screen display. The touch screen display will be nestled in the center of the dash, capable of simple extraction and secured adjustable placement for driver comfort and operation. The driver will basically have complete control of the entire vehicle via these two displays. An advanced operator, computer literate individual, or service and repair technician will be able to access the vehicle's data for diagnostic information, service and adjustment, custom programming, etc. . . . Custom programming is accomplished by utilizing the computer's keyboard software to interact with the touch screen's display. Located centered in the dash below the touch screen display will reside a “Blu-ray disc writer”. This will be for uploading programs, music and etc. into the computer, plus downloading information onto a disc, and playing CD's and DVD's for driver and passenger enjoyment. Located centered in the dash below the Blu-ray disc writer will be computer connection ports, USB 3.0 (future standard), IEEE 1394, etc. . . .

How to implement MAW-DirectDrives into rail transportation is utilizing every wheel to assist in the performance of the motion, the drive units are reversed in their orientation and connected by the rear face from the outside in that the frame is the full width of the rail car/locomotive with the units having the connected wheels inside to ride on the narrow tracks, each rail car would be setup independently with a separate power reserve similar to the layout for vehicles in [0081], and the locomotive would possess an ability to supply electricity if needed otherwise they would just control the operations of the independent rail cars, with this setup acceleration and braking are spread out evenly and initiate quickly and smoothly.

What is claimed is:

1. A permanent magnets direct drive propulsion, brake and electrical generation unit for a wheel, said direct drive unit comprising: two assemblies that join together and interact; one rotating assembly called the Integrated drive-plate assembly, the face the connection point for securing a wheel, a strong sturdy casted metal disk with circular boss and stiff well-built solid shaft projecting back on center, all surfaces machined true, the boss bears ride of front grease seal, the shaft bears inner and outer taper roller bearings and threaded behind outer bearing an equidistance to a locking spanner nut whose outside diameter bears ride of rear grease seal, beyond the spanner nut a groove accepts an external retaining ring facilitating a spacing and shim washers between for positive locking of the two assemblies together, the machined casting locates and secures a rigid thickset cylindrical drive rotor possessing rare earth permanent magnet arc-segments on the inside and outside diameters to interact with the stationary power assembly, the drive rotor body bears between the inner and outer rings of magnet arc-segments disc magnets to interact with a hall-effects sensor projecting in from the back of the stationary power assembly; the stationary power assembly, a tough sturdy durable and dependable casted metal annular shaped mounting plate and matching built-in inward projecting cylindrical central wheel hub housing machined inside to match inner and outer seals and taper roller bearings outer dimensions, wheel hub housing and mounting plate wall thicknesses corresponds to material type, weight to bear plus intended application and supports itself or the article in need of rotational properties on its rear and holds in position two frameless direct drive permanent magnets BLDC stators equal in width to the wheel hub coming off the mounting plate interacting with the drive rotor, propelling and braking the Integrated drive-plate assembly with one stator, the second stator generating electricity assisting its own electrical supply by inputting back into its supply in proportion to its size and load reducing the burden on supply, for deliver via a computers control.

2. A pressurized liquid/gas actuated brake unit for rotating shafts within stationary housings, said brake unit comprising: one brake rotor casting; a metal disk and circular boss projecting in on center an equidistance to its travel on the shaft, boss bored depth of travel 0.032″ larger than diameter of shaft possessing one die spring longer than hole bored into its rear to maintain disengagement, six radial longitudinal concave grooves milled into shaft end, length of rotor travel, matching diameter of tungsten carbide metal balls in six holes 0.005″ oversize, bored into boss, length of travel, centered on bolt circle, held in by internal retaining ring set-in counterbore dimensioned for finished internal clearance allowing interlocking and travel in ball spline format, rotor face outer perimeter recessed to accept by bonding, brake surface carbon fiber reinforced ceramic insert, working on and against dimensional matching carbon Keviar annular brake pad, secured by its metal backing ring on hardened location pins drilled and pressed into stationary housing; brake housing secured to stationary housing incorporates metal brake cylinder plunger acting on thrust bearing set-in rotor back, with external O-ring, moving within tungsten carbide bushing pressed into housing projection jutting back on center, drilled and threaded for male quick disconnect fitting centered at rear for connection to computer controlled pressure input and/or release valve for operation.

3. An accelerated heat dissipating mounting back/ring for a frameless direct drive stator, said mounting back/ring comprising: one aluminum bronze cylindrical shaped casting; 0.375″ wider than the center mounted stator, rear 1.000″ inward from both sides, set-in to leave a wall thickness 0.250″ at bottom, cooling ribs 0.156″ thick, spaced 0.156″ apart, 0.078″ radius at top and bottom between ribs circumnavigate the rear diameter, mounting holes drilled and threaded on median diameter to accept screws fifty percent smaller in diameter than wall thickness 0.875″ deep, not to exceed 3.000″ spacing on center.

4. An annular two piece adjustable external housing seal and pressure vent for a permanent magnets direct drive propulsion, brake and electrical generation unit, said housing seal and pressure vent comprising: two parts each a 180 degree arc, 6061 Aluminum casting 0.500″ wide, 0.250″ thick, inside diameter matching outside diameter of housing, bonded on edge a 0.250″ high by 0.250″ wide Teflon V-lip seal calibrated to vent at 15 pounds internal pressure, each part has ten 0.190″ diameter holes elongated 0.125″ for adjustability, matching threaded mounting holes on housing, starting 9 degrees inward from 180 degree plane, centered 18 degrees apart.

5. A compressed air cooling system for a permanent magnets direct drive propulsion, brake and electrical generation unit, said compressed air cooling system comprising: addition of outer wall 0.625″ thick, equal in height to overall width of widest stator, sunken 0.250″ deep cooling chamber centered 0.750″ inward form face and inside back, 0.375″ diameter hole centered within outer wall terminates 0.750″ into chamber initiated through center of 0.375″ NPT threaded hole on rear face of stationary power assembly fitted with 0.375″ male quick-disconnect plug with 0.250″ body for connection to computer controlled air valve fed by compressor storage tank, inner and outer stators mounting back/ring rear grooved to accept 0.250″ O-ring starting 0.250″ from face, ring face 0.188″ stator setback ledge accommodates 2.25 mm diameter compressed air and heat exit holes angling 37.5 degrees back toward cooling chambers, outer stator; 18 holes, 12 at rear 30 degrees apart on center 6 at front 60 degrees apart on center, inner stator; 8 holes, 4 at front and rear 90 degrees apart on center, inner and outer stators clearance to corresponding diameter not to exceed 0.032″ to maintain proper O-ring contact, wheel hub outside diameter sunken cooling chamber 0.188″ deep centered 0.750″ inward matching outer wall, 0.250″ diameter hole centered 0.188″ inward terminates 0.500″ into chamber initiated through center of 0.250″ NPT threaded hole on rear face of stationary power assembly fitted with 0.250″ male quick-disconnect plug with 0.375″ body for connection to second computer controlled air valve.

6. A liquid and compressed air cooling system for a permanent magnets direct drive propulsion, brake and electrical generation unit, said liquid and compressed air cooling system comprising: addition of outer wall 0.625″ thick, equal in height to overall width of widest stator, sunken 0.250″ deep coolant chamber centered 0.750″ inward from face and inside back, partitioned with 0.625″ wide wall 0.250″ high, two 0.375″ diameter holes centered within outer wall, separated 2.125″ on center, equidistance from partition wall centerline, terminating 0.750″ into chamber, initiated through centers of two 0.375″ NPT threaded holes on rear face of stationary power assembly each fitted with 0.375″ inside diameter threaded hose fittings, connections for input and output, input from computer controlled valve receiving coolant from pressurized reservoir maintained by submerged pump at base of radiator, output to radiator, inner and outer stators mounting back/ring rear grooved to accept 0.250″ O-ring starting 0.250″ from face, inner and outer stators clearance to corresponding diameter not to exceed 0.032″ to maintain proper O-ring contact, wheel hub outside diameter sunken coolant chamber 0.188″ deep centered 0.750″ inward matching outer wall, partitioned with 0.625″ wide wall 0.188″ high, two 0.250″ diameter holes centered 0.188″ inward, separated 2.125″ on center, equidistance from partition wall centerline, terminate 0.500″ into chamber, initiated through centers of two 0.250″ NPT threaded holes on rear face of stationary power assembly each fitted with 0.250″ inside diameter threaded hose fittings, connections for input from second computer controlled valve and output to radiator, computer controlled compressed air input line located on drive rotor median diameter within connections group.
